(19) United States
(12) Patent Application Publication
(10) Pub. No.: US 2026/0021476 A1
(43) Pub. Date: Jan. 22, 2026

(54) VISIBLE LIGHT ACTIVATED PHOTOCATALYSTS FOR AIR PURIFICATION PRODUCTS

(71) Applicant: Nano and Advanced Materials Institute Limited, Hong Kong (HK)

(72) Inventors: Jianying MIAO, Hong Kong (HK); Aristyo SOECIPTO, Hong Kong (HK); Shuping LIN, Hong Kong (HK); Wing Ho CHOI, Hong Kong (HK)

(21) Appl. No.: 18/774,939

(22) Filed: Jul. 17, 2024

(51) Int. Cl. B01J 23/30; B01J 35/39; B01J 35/45; B01J 37/03

(52) U.S. Cl. CPC B01J 23/30; B01J 35/39; B01J 35/45; B01J 37/031

(57) ABSTRACT

A method for making a nanoparticle-sized WO₃-based photocatalyst for activation by visible light and/or UV light. The method includes providing a tungsten precursor including tungstic acid. A shape template is provided for creating discrete nano-sized WO₃-based photocatalyst particles. The shape template may be selected from one or more organic acid or salt. The tungsten precursor and the shape template are reacted in one or more solvents at a temperature lower than 200° C. followed by precipitating the discrete nano-sized WO₃-based photocatalyst particles. In a further aspect, the WO₃-based photocatalyst particles may be assembled into fuzzy flower morphologies. The nanoparticle-sized WO₃-based photocatalysts may be doped with a transition metal, a transition metal oxide, or a transition metal ion. The transition metal, a transition metal oxide, or a transition metal ion may be one or more of Ti, Mn, Fe, Cu, Ag, Zn, or Al.

### TECHINCAL FIELD

The present invention relates to photocatalysts activated by visible light, methods for fabricating these photocatalysts, and air purification products incorporating these photocatalysts including paints and other coatings capable of virus inactivation, bacteria removal and mold neutralization.

### BACKGROUND

Indoor air quality has raised concerns in recent years. Removal of various indoor environmental air pollutants, including particulate matter (PM), volatile organic compounds (VOCs), hydrocarbons, tobacco smoke and bio-pollutants is desirable for healthy indoor air. Especially after the recent COVID-19 pandemic, effective approaches to indoor air purification are increasingly important.

Photocatalytic oxidation (PCO) removes air pollutants by activating radiation of particular wavelength ranges to convert air impurities such as VOCs, formaldehyde, and bio-pollutants (viruses, bacteria, molds) into harmless products. Through irradiation, reactive oxygen species (ROS) such as hydroxyl radicals (·OH) and super oxide anions (O₂⁻·) are generated; these are effective in killing viruses, bacteria and molds.

Until recently, titanium dioxide (TiO₂) has been the most widely-used photocatalyst for air purification. However, TiO₂ responds only to UV radiation. Therefore, incorporation of TiO₂ in paints or coatings provides insufficient indoor air purification since there are inadequate levels of UV in indoor environments.

Thus, there is a need in the art for improved photocatalytic materials. Such materials can be incorporated into paints, coatings, and other products for improving indoor air quality.

### SUMMARY OF THE INVENTION

In one aspect, the present invention provides a method for making a nanoparticle-sized WO₃-based photocatalyst for activation by visible light and/or UV light. The method includes providing a tungsten precursor such as tungstic acid. A shape template is provided for creating discrete nano-sized WO₃-based photocatalyst particles. The shape template is selected from one or more organic acid or salt. The tungsten precursor and the shape template are reacted in one or more solvents at a temperature lower than 200° C. followed by precipitating the discrete nano-sized WO₃-based photocatalyst particles.

In a further aspect, the WO₃-based photocatalyst particles are assembled into fuzzy flower morphologies.

In a further aspect, the nanoparticle-sized WO₃-based photocatalysts are doped with a transition metal, a transition metal oxide, or a transition metal ion.

The transition metal, a transition metal oxide, or a transition metal ion may be added to the tungsten precursor and the shape template in one or more solvents.

Alternatively, the transition metal, a transition metal oxide, or a transition metal ion may be added to the discrete nano-sized WO₃-based photocatalyst particles.

In one aspect, a surfactant may be added to the one or more solvents.

The shape template may include one or more of oxalic acid or ammonia oxalate.

The transition metal of the transition metal, a transition metal oxide, or a transition metal ion may be one or more of Ti, Mn, Fe, Cu, Ag, Zn, or Al.

In a further aspect, a coating for inactivating virus, removing bacteria and/or inactivating mold may be formed by adding the nanoparticle-sized WO₃-based photocatalyst into a paint or polymer coating.

In a further aspect, a copper foam infused with the WO₃-based photocatalyst comprising may be made by infiltrating a copper foam with a slurry of the catalyst and adhesive by, for example, dipping, immersion, or spraying.

### BRIEF DESCRIPTION OF DRAWINGS

The appended drawings, where like reference numerals refer to identical or functionally similar elements, contain FIG.s of certain embodiments to further illustrate and clarify the above and other aspects, advantages and features of the present invention. It will be appreciated that these drawings depict embodiments of the invention and are not intended to limit its scope. The invention will be described and explained with additional specificity and detail through the use of the accompanying drawings in which:

FIGS. 1A-1D depict WO₃-based photocatalysts comprising fuzzy flower-like assemblies formed according to Example 1 of the present invention;

FIGS. 2A-2D show a Field Emission SEM (FESEM) image of CuO-doped WO₃-based photocatalyst comprising fuzzy flower-like assemblies formed according to Example 2 of the present invention;

FIG. 3A shows acrylic paint to be mixed with the as-formed WO₃-based photocatalyst of FIG. 3B while FIG. 3C shows the mixture coated on substrates for performance testing, the virus (H1N1) inactivation test result of which is tabulated in Table 1 below;

FIGS. 4A-4B show an antibacterial test (E. coli) result for acrylic-based paint without and with WO₃-based catalyst. FIG. 4A shows the substrates coated with acrylic-based paint; FIG. 4B shows the coated substrates under microscope in feeding bacteria of E. Coli; the performance test result of removing E. Coli for acrylic-based paint with WO₃-based catalyst is tabulated in Table 2 below;

FIG. 5 shows the acrylic-based paints with different colors added with WO₃-based catalyst, the antibacterial test (E. coli) results of which are tabulated in Table 4 below;

FIGS. 6A-6C shows the resin-based paint (FIG. 6A) to which is added WO₃-based photocatalyst (FIG. 6B) along with paint-coated substrates for testing (FIG. 6C);

FIG. 7A shows a foam impregnated with WO₃-based photocatalyst while FIG. 7B depicts air ducts coated with WO₃-based catalysts;

FIG. 8A depicts the morphology of conventional WO₃ particles depicting large platelet shapes that easily agglomerate, reducing potential catalytic sites compared to WO₃-based catalysts formed according to the present invention (FIG. 8B).

### DETAILED DESCRIPTION

Tungsten oxide, WO₃, is a promising candidate for photocatalytic oxidation by visible light. WO₃ absorbs photons and generates electron-hole pairs. WO₃ has a band gap of about 2.6-2.8 eV, which allows it to utilize visible light. The photo-generated electrons and holes must be effectively separated to prevent recombination. In WO₃, this separation is facilitated by its crystalline structure and electronic properties. The electrons reduce water to produce hydrogen gas (H₂), while the holes oxidize water to produce oxygen gas (O₂). In particular WO₃ generates reactive oxygen species (ROS) such as hydroxyl radicals (·OH) and superoxide anions (O₂·⁻). Optionally, dopants (for example, transition metals) may be introduced to change the bandgap structure and improve the photocatalytic properties.

Coatings including WO₃ can become super-hydrophilic when irradiated with visible light, causing water to form as thin surface films rather surface droplets; these thin films can enhance self-cleaning of surfaces including WO₃.

However, effective formation of reactive oxygen species requires adsorption of oxygen on the WO₃ surface as well as separation of electrons and holes in the WO₃ crystal structure. Therefore, the morphology of the WO₃ used for photocatalysis greatly impacts its efficiency. Very small particles are beneficial for postponing the recombination of photogenerated electrons and holes, therefore providing better photocatalytic performance.

Due to their high surface area and other desirable morphological features, formation of WO₃ nanoparticles may provide greater photocatalytic activity than conventional structures. However, conventional hydrothermal methods for preparing WO₃ require high pressure and/or relatively high temperature (180° C.). In addition, even for small WO₃ particles, such as conventional nanoparticles or nanospheres, the photocatalytic performance is low. Consequently, such WO₃ particles typically require mixture with rare metals/metal oxides to enhance the photocatalytic performance in coatings. Further, conventional WO₃ particles easily aggregate to form large and dense aggregates; these aggregates have low surface areas reducing potential catalysis sites.

In contrast the prior art aggregates, the present invention creates a “fuzzy flower-like” structure of WO₃ nanoparticles through shape templates that control the particle growth, creating a material with a large surface area and improved photocatalytic properties. Flower-like nanoparticles are nanocrystals formed in a three-dimensional flower-like shape. The “fuzzy” flower-like structure is formed from larger particle aggregates that have millions of very small nanoparticles on their surfaces, creating a fuzzy, fur-like appearance. In general, longer reaction times and more conducive to creating this structure. Typically, these tungsten oxide (WO₃) fuzzy flower-like assemblies are nanoparticles with an average size on the order of 20-500 nm, with larger assemblies on the order of 500 nm to 10 um, which may include smaller nanoparticles and micron-sized particles. They have high specific surface areas, providing many active sites for catalytic reactions. The as-prepared WO₃-based photocatalyst can incorporated into air purification produces, coatings, or paints capable of virus, bacteria, and mold inactivation, as well as VOC neutralization.

Optionally, the WO₃-based photocatalysts may include a non-precious metal, including titanium (Ti), manganese (Mn), iron (Fe), copper (Cu), silver (Ag), zinc (Zn), or aluminum (Al). The metal can be in the form of a metal, metal ion or metal oxide. The fabrication technique of the present invention readily permits the incorporation of these dopants. Further, precious catalytic metals such as platinum are not required in the WO₃-based photocatalysts formed by the present invention.

Fabrication of the WO₃-based photocatalysts of the present invention uses a top-down technique that creates smaller particles with greater surface area than the conventional bottom-up fabrication. The top-down approach reacts a tungsten precursor, such as tungstic acid, with a selected shape template to create separate nano-sized particles of WO₃-based photocatalysts. The tungstic acid may have one or more H₂O molecules and a selected starting particle size through pre-reaction grinding, creating a particle size on the order of several hundred microns. Using this tungsten precursor and shape template, along with one or more solvents, surfactants (for example, sulfonate-based surfactants)), and optional additional metal-based additives (metal ions/metal oxides), small particle precipitants are formed through reactant mixing for at least 5 hours, at an elevated temperature below 200° C., such as 80-100° C. During mixing, the reactant liquid changes color from bright yellow to a lighter yellow; flocculent precipitates may be observed. The precipitate is separated by filtering or centrifuging followed by drying. The drying temperature may be higher than approximately 100° C., but lower than approximately 200° C. Optionally, a vacuum heating system may be used, such that the drying temperature may be lower. The drying time may be approximately one hour or more.

Following drying, the precipitants assemble to form fuzzy flower-like structures. This top-down approach to form WO₃-based photocatalysts is both low-cost and scalable to commercial production requirements.

The shape template for the WO₃-based photocatalysts may be an organic acid or salt, such as oxalic acid or ammonia oxalate, which will induce the final product of WO₃ particles to have a nano-plate/nano-sheet morphology. Polymers such as polyethylene glycol (PEG), with various molecular weights, create WO₃ particles having more of a nano-rod/nano-needle morphology.

WO₃-based photocatalyst can be used independently, or doped with other metal component, which can be a non-precious metal, including Ti, Mn, Fe, Cu, Ag, Zn, or Al. The metal could exist as metal, metal ion or metal oxide. When the WO₃-based photocatalyst incorporates a doping metal or metal oxide, metal-containing particles may be added by mixing them with the initial reactants or, alternatively, into the precipitated WO₃-based photocatalyst particles.

The formed WO₃-based photocatalyst with or without metal, metal ion or metal oxide dopants, is incorporated into air purification products such as coatings, paint, or self-cleaning surfaces. Generally, the color of the painting or coating will not be affected by adding the WO₃-based photocatalyst. The coated or painted surfaces are activated by visible light or visible and UV light. In addition to coatings, the WO₃-based photocatalysts may be coated on metal surfaces, such as metal foams, sheets, plates, or blocks. In one embodiment, the photocatalysts can be incorporated into an adhesive, such as an epoxy-based adhesive, with various air purification articles immersed into the slurry of catalyst and epoxy. Alternatively, WO₃-based photocatalysts may be applied to air purification device surfaces by spraying or sol-gel based processes. Further, the WO₃-based photocatalysts may be incorporated into composite materials.

### EXAMPLES

### Example 1: Fabrication of WO₃-Based Photocatalyst With Fuzzy Flower-Like Assemblies

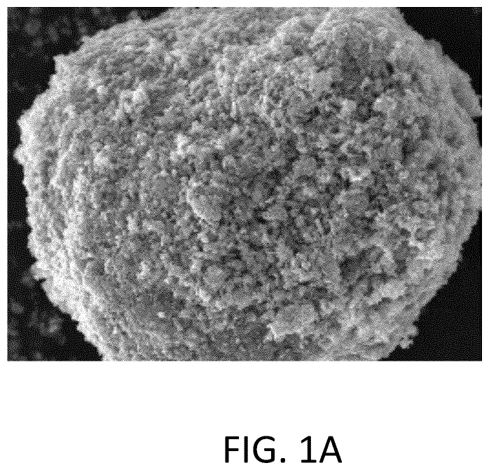

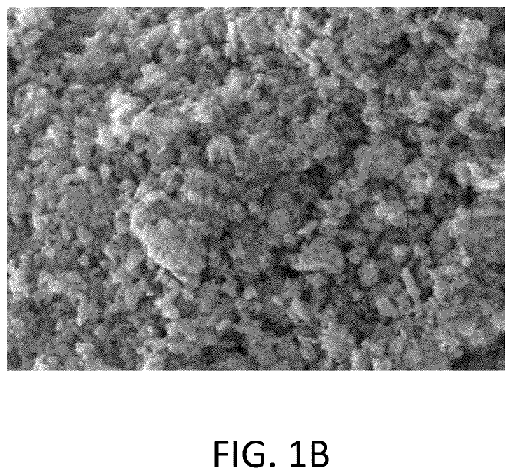

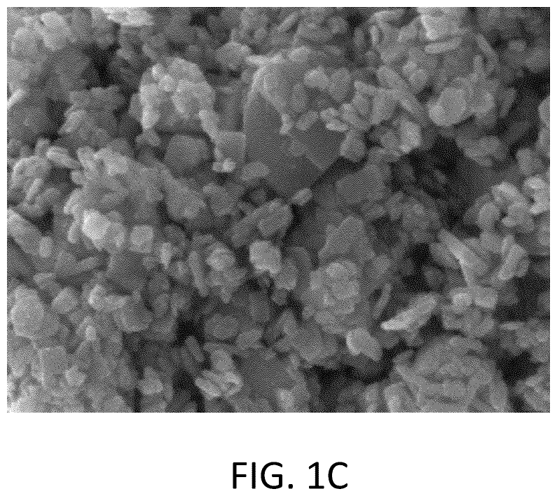

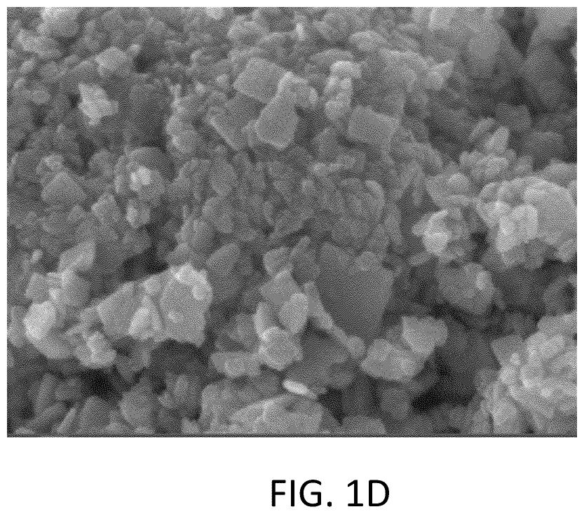

Tungstic acid (14 g, H₂WO₄) as the tungsten precursor, oxalic acid (6.75 g, H₂C₂O₄) as the shape template of separate nano-sized particle of WO₃-based photocatalyst, DI water (200 mL, H₂O) as solvent/dispersion agent, sodium dodecyl sulfonate (0.1%, CHNaO₃S) as surfactant are mixed together. The mixture is stirred at a temperature of 90° C. After reacting for 10 hours while stirring, the mixture product changes to light yellow with precipitate from bright yellow (the color change is slight and may not be clearly apparent). The precipitate is separated by filtering or centrifuging. The as-prepared WO₃-based photocatalyst is then washed with deionized water and then ethanol for 3 times, respectively, followed by drying at 100° C. A WO₃-based photocatalyst is obtained with a morphology as shown in the SEM image of FIGS. 1A-1D.

### Example 2: Preparation of CuO-Doped WO₃-Based Photocatalyst

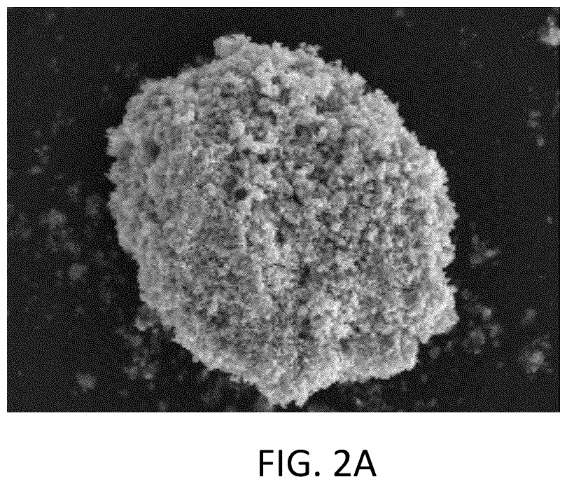

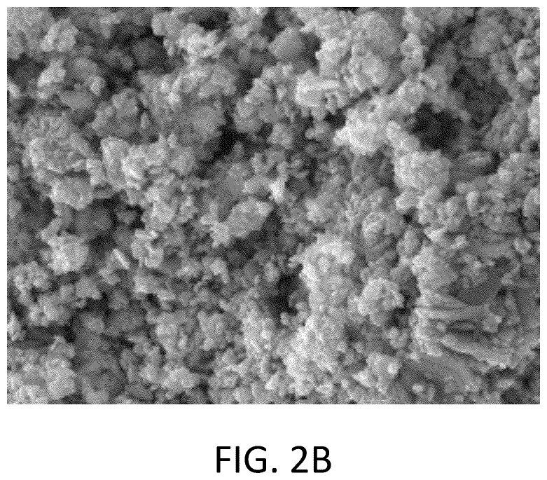

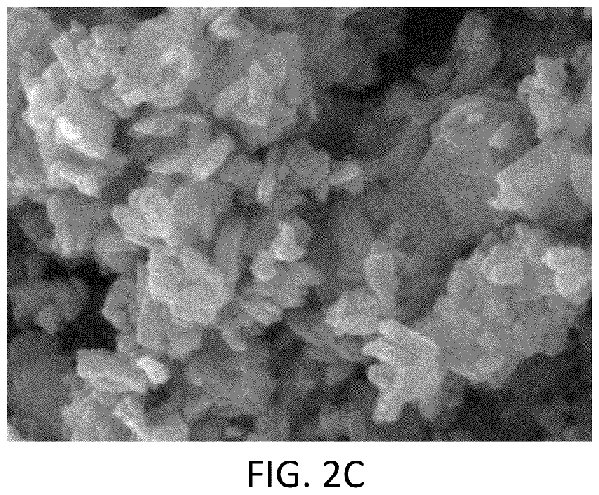

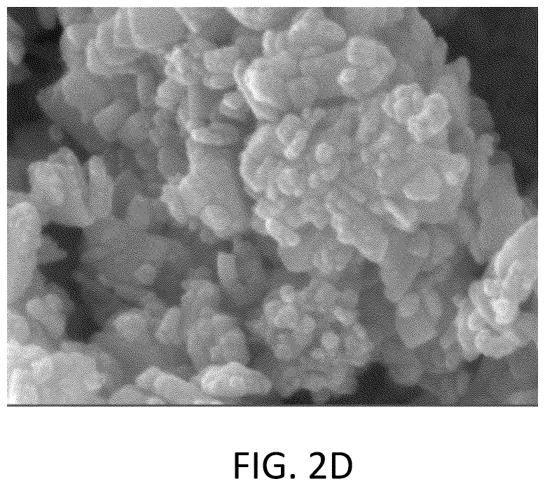

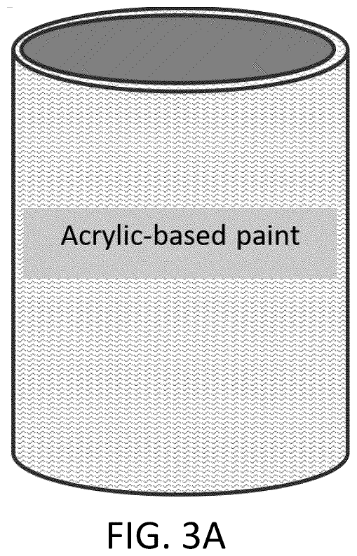

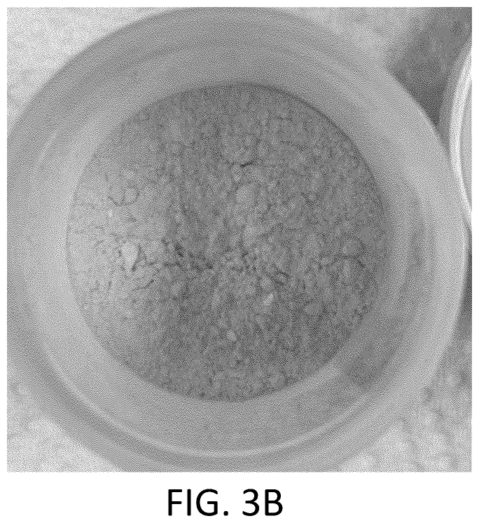

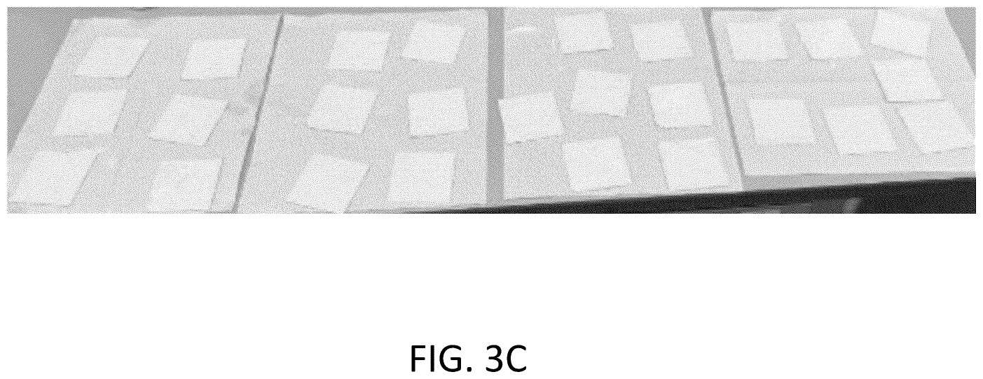

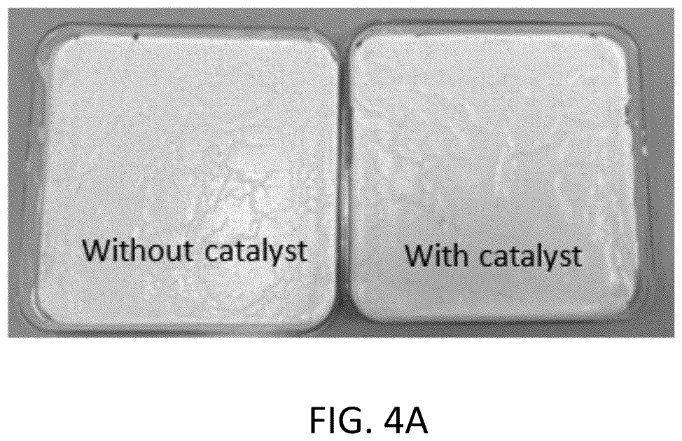

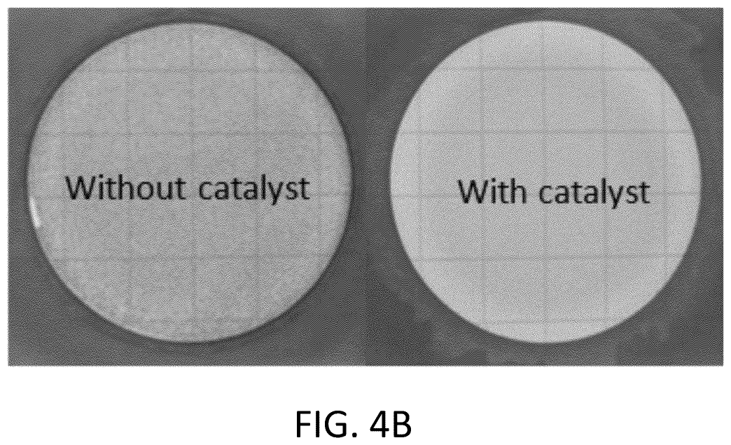

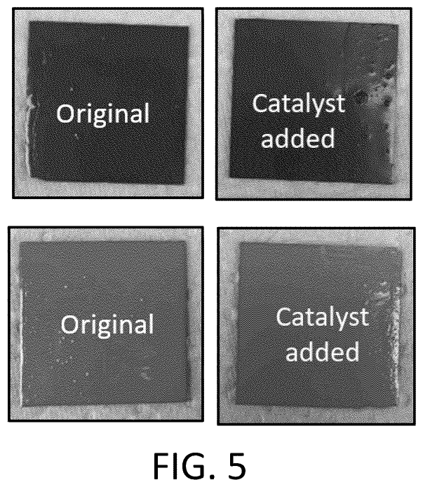

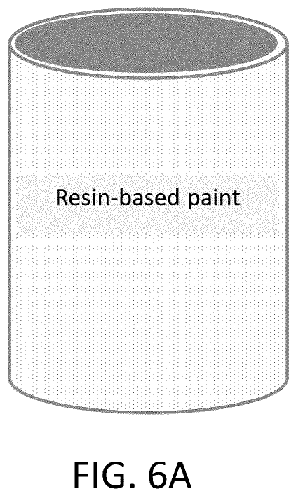

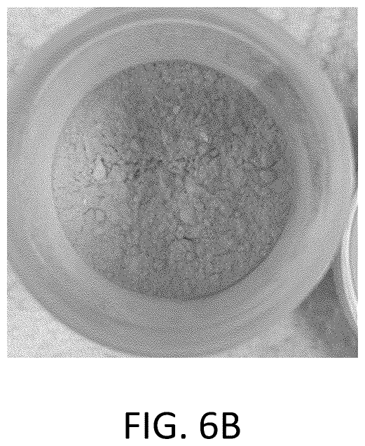

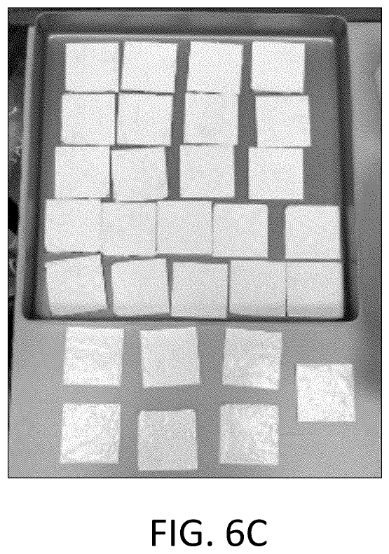

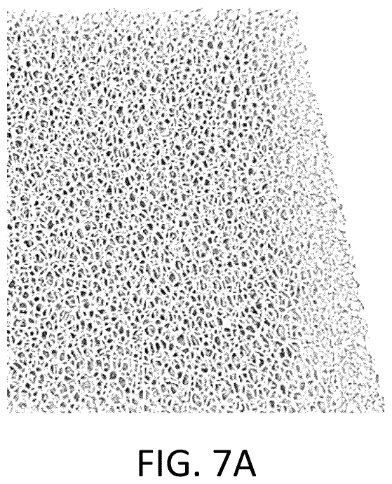

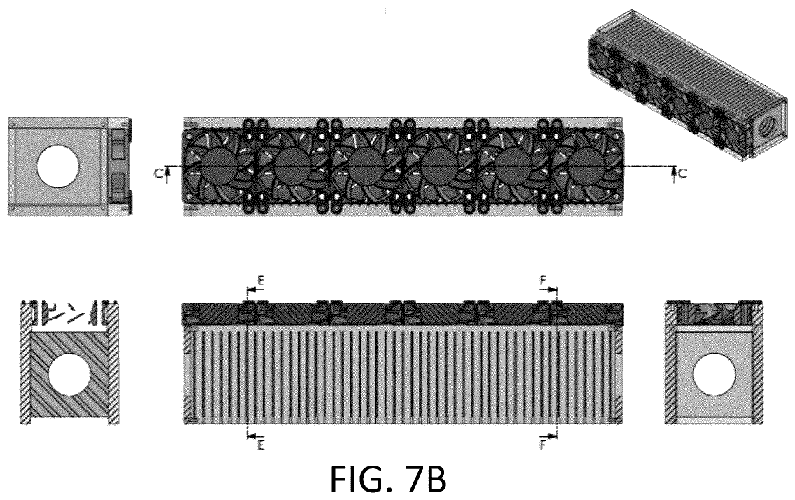

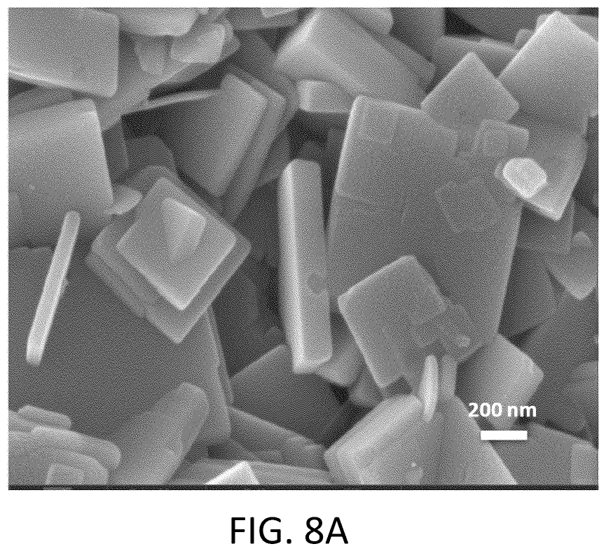

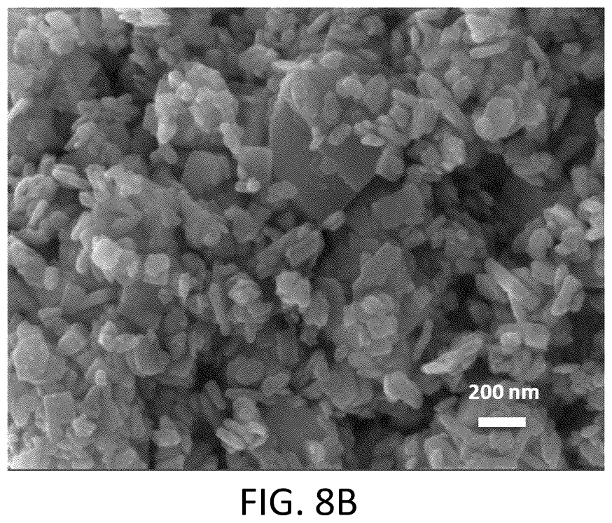

A CuO-doped WO₃-based photocatalyst is formed, including 99.5 wt % of WO₃ and 0.5 wt % of copper oxide. The photocatalyst is prepared by mixing the WO₃ precipitate of Example 1 with particulate CuO at the above weight ratio, followed by grinding at room temperature for 10 min. FIG. 2 shows the SEM image of CuO-doped WO₃-based photocatalyst comprising fuzzy flower-like assemblies.

### Example 3: Preparation of Acrylic-Based Paint With Added WO₃-Based Photocatalyst

The WO₃-based photocatalyst of Example 1 is mixed into a commercially-available acrylic-based paint at a mixing ratio of 1.2 wt %. The WO₃-based photocatalyst particles are mixed into the paint by stirring at room temperature for at least 10 minutes. Alternatively, a slurry of WO₃-based photocatalyst particles may be mixed with a small amount of paint; the slurry is then added into a larger volume of paint to form the 1.2 wt % ratio. The as-prepared acrylic-based paint added is coated onto substrates for performance testing according to industrial standards for virus and mold inactivation and bacteria removal.

### Example 4: Preparation of Resin-Based Paint Added With WO₃-Based Photocatalyst

The WO₃-based photocatalyst of Example 1 is mixed into a commercially-available resin-based paint at a ratio of 1.2 wt %. The WO₃-based photocatalyst particles are mixed into the paint by stirring at room temperature for at least 10 minutes. Alternatively, a slurry of WO₃-based photocatalyst particles may be mixed with a small amount of paint; the slurry is then added into a larger volume of paint to form the 1.2 wt % ratio. The as-prepared resin-based paint added is coated onto substrates for performance testing according to industrial standards for virus and mold inactivation and bacteria removal.

To evaluate the performance of virus inactivation and bacteria removal for the acrylic-based and resin-based paint added with WO₃-based photocatalyst, test standard and method will follow ISO 18701-2016 and ISO 22196:2011 (E)/JIS Z 2801:2012, respectively.

To prepare the test specimens, acrylic-based and resin-based paint added with WO₃-based photocatalyst were coated on sheet substrates, such as glass, stainless steel (SS) or plastics. General coating method was used, including brushing, bar coating, spraying et al. After coating paint added with WO₃-based photocatalyst on substrates, these samples will be dried at room temperature or heated at temperature below 100° C., and then delivered to the 3^{rd} party for performance test of virus inactivation, bacteria removal, and anti-mold et al.

Examples of the performance test for virus inactivation, bacteria removal, and anti-mold et al. are shown in Tables 1-7 below.

TABLE 1
Test results for acrylic-based paint with added
WO₃-based photocatalyst for inactivating virus (H1N1)

| | | Virus Titer (TCID₅₀/cm²))/Virus Titer | | | | Antiviral |
|---|---|---|---|---|---|---|
| The Test Virus | Test | Log Value [log (TCID₅₀/cm²)] | | | | Activity Rate |
| and Host | Group | First Test | Second Test | Third Test | Mean | R′ (%) |
| Influenza | 0 h Control | 7.4 × 10⁵ | 5.8 × 10⁵ | 5.8 × 10⁵ | 6.3 × 10⁵ | >99.99 |
| A virus | Group | 5.9 | 5.8 | 5.8 | 5.8 | |
| (A/PR/8/34 | 24 h Control | 5.8 × 10⁵ | 2.7 × 10⁵ | 2.1 × 10⁵ | 3.5 × 10⁵ | Antiviral Activity |
| H1N1) | Group | 5.8 | 5.4 | 5.3 | 5.5 | Value R |
| Host: MDCK | | | | | | [log (TCID₅₀/cm²)] |
| cells | 24 h Test | <4.0 | <4.0 | <4.0 | <4.0 | >4.9 |
| | Group | <0.6 | <0.6 | <0.6 | <0.6 | |

Note:
The first line of each test group is the virus titer, and the second line is the logarithm of the virus titer.

TABLE 2
Performance test result of removing E. Coli for acrylic-based paint with WO₃-based catalyst

| | Untreated sample | | Treated sample | |
|---|---|---|---|---|
| | Average of | Average of | Average of | Value of |
| | logarithmic value | logarithmic value of | logarithmic value of | Antibacterial |
| Bacteria | of viable cell count | viable cell count | viable cell count | Activity |
| inocluated | (T = 0) | (T = 24) | (T = 24) | (R) |
| Escherichia coli | 4.1101 | 5.5402 | 0.0177 | 5.5224 |
| (ATCC 8739) | | | | |

The initial concentration of E. coli is 150,000,000 CFU/ml ∘

TABLE 3
Anti-mold test (P. Pinophilum) result of the
acrylic-based paint added with WO₃-based catalyst

| | Test Bacteria |
|---|---|
| | Penicilium Pinophilum |
| Test Items | (CGMCC 3.8028) |
| Average bacteria count on control sample | 3.3 × 10⁵ |
| after 0 h treatment (CFU) | |
| Average bacteria count on control sample | 7.6 × 10⁶ |
| after light treatment C₀ (CFU) | |
| Average bacteria count on control sample | 2.2 × 10⁵ |
| after light treatment C₁(CFU) | |
| Average bacteria count on control sample | 2.1 × 10⁵ |
| after dark treatment B₁ (CFU) | |
| Antibacterial Rate R (%) | 97.07 |
| Antimicrobial contribution value R (%) | 0 |

TABLE 4
Antibacterial test (E. coli) results of the acrylic-based
paints with different colors added with WO₃-based catalyst

| | | Untreated sample | | Treated sample | |
|---|---|---|---|---|---|
| | | Average of | Average of | Average of | |
| | | logarithmic | logarithmic | logarithmic | Value of |
| | | value of viable | value of viable | value of viable | Antibacterial |
| Bacteria | Testing | cell count | cell count | cell count | Activity |
| inoculated | groups | (T = 0) | (T = 24) | (T = 24) | (R) |
| Escherichia coli | Green acrylic- | 4.3100 | 6.3214 | 0.0177 | 6.3037 |
| (ATCC 8739) | based paint | | | | |
| | added with | | | | |
| | WO₃-based | | | | |
| | catalyst | | | | |
| | Blue acrylic- | 4.3100 | 6.3214 | 3.2754 | 3.0460 |
| | based paint | | | | |
| | added with | | | | |
| | WO₃-based | | | | |
| | catalyst | | | | |

TABLE 5
Test results for resin-based paint with added WO₃-based photocatalyst for inactivating virus (H1N1)

| | | | | Average | Average | |
|---|---|---|---|---|---|---|
| | | | Logarithm of | logarithm of | logarithm of | Average |
| | | | infectivity | infectivity | infectivity | infectivity |
| Virus and | Action | | titre | titre | titre | titre |
| host cell | time | Group | (lgTCID₅₀/mL) | (lgTCID₅₀/mL) | (lgTCID₅₀/mL) | (TCID₅₀/mL) |
| Influenza | 0 h | Control group 1 | 5.59 | 5.60 | 6.60 | 3.95 × 10⁶ |
| A virus | | Control group 2 | 5.61 | | | |
| (A/PR/8/34 | | Control group 3 | 5.59 | | | |
| H1N1) | Dark | Control group 1 | 4.80 | 4.73 | 5.73 | 5.37 × 10⁵ |
| Host: MDCK | conditions | Control group 2 | 4.67 | | | |
| cells | 8 h | Control group 3 | 4.71 | | | |
| | | Test group 1 | 2.64 | 2.63 | 3.63 | 4.31 × 10³ |
| | | Test group 2 | 2.59 | | | |
| | | Test group 3 | 2.67 | | | |
| | Light | Control group 1 | 4.50 | 4.54 | 5.54 | 3.47 × 10⁵ |
| | conditions | Control group 2 | 4.61 | | | |
| | 8 h | Control group 3 | 4.50 | | | |
| | | Test group 1 | <1.50 | <1.50 | <2.50 | <3.16 × 10² |
| | | Test group 2 | <1.50 | | | |
| | | Test group 3 | <1.50 | | | |

| Antiviral activity value | >3.04 | The percentage | >99.91 |
|---|---|---|---|
| The photocatalyst antiviral activity | >0.94 | The percentage | >88.54 |
| value with light | | | |
| Antiviral activity value | 2.10 | The percentage | 99.20 |
| without photocatalyst | | | |

Light condition is provided using fluorescent lamp with illumination intensity 1000Lx °

TABLE 6
Antibacterial test (E. coli) result for resin-based
paint with and without WO₃-based catalyst additives

| | Untreated sample | | Treated sample | |
|---|---|---|---|---|
| | Average of | Average of | Average of | Value of |
| | logarithmic value | logarithmic value of | logarithmic value of | Antibacterial |
| Bacteria | of viable cell count | viable cell count | viable cell count | Activity |
| inoculated | (T = 0) | (T = 24) | (T = 24) | (R) |
| Escherichia coli | 4.3100 | 6.3214 | 1.9471 | 4.3742 |
| (ATCC 8739) | | | | |

The initial concentration of Escherichia coli is 1,400,000 CFU/ml.

TABLE 7

| | Test Bacteria |
|---|---|
| | Penicilium Pinophilum |
| Test Items | (CGMCC 3.8028) |
| Average bacteria count on control sample | 3.5 × 10⁵ |
| after 0 h treatment (CFU) | |
| Average bacteria count on control sample | 9.5 × 10⁵ |
| after light treatment C₀ (CFU) | |
| Average bacteria count on control sample | 2.5 × 10³ |
| after light treatment C₁(CFU) | |
| Average bacteria count on control sample | 6.3 × 10⁴ |
| after dark treatment B₁ (CFU) | |
| Antibacterial Rate R (%) | 99.74 |
| Antimicrobial contribution value R (%) | 96.03 |

### Example 5: Application Example of WO₃-Based Photocatalyst With or Without the Doped Metal, Metal Ion or Metal Oxide on Metal Sheets or Foams for Air Ducts or Air Duct Coatings

A WO₃-based catalyst was dispersed in the mixture of DI water and epoxy resin to get the catalyst slurry, by stirring with a magnetic bar to prevent the deposition of catalyst powder, which was contained in a 3 L beaker. The content of the catalyst slurry sample is 200 g of DI water, 400 g of epoxy resin and 6 g of WO₃-based catalyst. Copper foam (FIG. 12A) was immersed into above beaker for 1 min., and then lifted, dried and washed. This impregnated copper foam may optionally be positioned on a metal sheet. The coated metal sheet may be then be assembled to form the air duct shown FIG. 12B.

### Comparative Example

FIG. 13A depicts WO₃ particles formed by a prior art technique based on the use of a tungsten salt decomposed using a strong acid. In this method, sodium tungstate is reacted with hydrochloric acid; oxalic acid is present and acts as a morphology template,. A precipitate appears after reacting for 6 hrs. or longer. However, reaction for longer times such as 16 hrs are needed to create sufficient precipitates. As seen in FIG. 13A, the formed WO₃ particles are platelets or rod-like particles, with a major dimension on the order of 500 nm to over 1 micron. In contrast, the WO₃ particles formed by the technique of Example 1 shown in FIG. 13B result in extremely small nanoparticles, on the order of 20-50 nm.

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

It will be appreciated by those skilled in the art, in view of these teachings, that alternative embodiments may be implemented without undue experimentation or deviation from the spirit or scope of the invention, as set forth in the appended claims. This invention is to be limited only by the following claims, which include all such embodiments and modifications when viewed in conjunction with the above specification and accompanying drawings.

1. A method for making a nanoparticle-sized WO₃-based photocatalyst for activation by visible light and/or UV light comprising:
providing a tungsten precursor including tungstic acid;
providing a shape template for creating discrete nano-sized WO₃-based photocatalyst particles, the shape template selected from one or more organic acid or salt;
reacting the tungsten precursor and the shape template in one or more solvents at a temperature lower than 200° C.;
precipitating the discrete nano-sized WO₃-based photocatalyst particles.

2. The method for making the nanoparticle-sized WO₃-based photocatalyst of claim 1, further comprising heating the WO₃-based photocatalyst particles to assemble into fuzzy flower morphologies.

3. The method for making the nanoparticle-sized WO₃-based photocatalyst of claim 1, further comprising doping the nanoparticle-sized WO₃-based photocatalyst particles with a transition metal, a transition metal oxide, or a transition metal ion.

4. The method for making the nanoparticle-sized WO₃-based photocatalyst of claim 3, wherein the transition metal, a transition metal oxide, or a transition metal ion is added to the tungsten precursor and the shape template in one or more solvents.

5. The method for making the nanoparticle-sized WO₃-based photocatalyst of claim 3, wherein the transition metal, a transition metal oxide, or a transition metal ion is added to the discrete nano-sized WO₃-based photocatalyst particles.

6. The method for making the nanoparticle-sized WO₃-based photocatalyst of claim 1, further comprising adding a surfactant to the one or more solvents.

7. The method for making the nanoparticle-sized WO₃-based photocatalyst of claim 1, wherein the shape template includes one or more of oxalic acid or ammonia oxalate.

8. The method for making the nanoparticle-sized WO₃-based photocatalyst of claim 3, wherein the transition metal of the transition metal, a transition metal oxide, or a transition metal ion is Ti, Mn, Fe, Cu, Ag, Zn, or Al.

9. The method for making a coating for inactivating virus, removing bacteria and/or inactivating mold comprising adding the nanoparticle-sized WO₃-based photocatalyst of claim 1 into a paint or polymer coating.

10. A method for making a slurry for coating on metal foams comprising mixing the WO₃-based photocatalysts of claim 1 with an adhesive.

11. A method for making a copper foam infused with a WO₃-based photocatalyst comprising infiltrating a copper foam with the slurry of claim 10.
